(19) United States
(12) Patent Application Publication
(10) Pub. No.: US 2026/0320764 A1
(43) Pub. Date: Oct. 15, 2026

(54) METHOD AND SYSTEM

(71) Applicant: PLANNA LIMITED, London (GB)

(72) Inventors: Alain HANASH, London (GB); Brooke WILLIAMS, London (GB); Sharaf YAMANI, London (GB)

(21) Appl. No.: 19/485,230

(22) PCT Filed: Apr. 19, 2024
(86) PCT No.: PCT/EP2024/060830

§ 371 Date: Nov. 17, 2025

(30) Foreign Application Priority Data
May 18, 2023 (GB) 2307479.2

(51) Int. Cl. G06T 7/00; G06V 10/25; G06V 10/764; G06V 10/774; G06V 10/82; G06V 20/10

(52) U.S. Cl. CPC G06T 7/0002; G06V 10/25; G06V 10/764; G06V 10/774; G06V 10/82; G06V 20/176; G06T 2207/10024; G06T 2207/20081; G06T 2207/20084; G06T 2207/30184; G06V 2201/10

(57) ABSTRACT

A computer-implemented method of identifying a fault in a building includes training a data model to determine a the presence in a content item of a characteristic associated with a fault in a building. The training includes providing a plurality of training content items, each training content item pertaining to a type of fault which can occur in a building among a plurality of faults which can occur in a building, and for a given training content item among the plurality, providing a training input including a label for a feature of interest associated with a type of fault in the given training image; providing a training output identifying the type of fault associated with the feature of interest pertaining to the label.

### FIELD

The invention relates to a method and system. Particularly, but not exclusively, the invention relates to a computer implemented method and system. Further particularly, but not exclusively, the invention relates a computer implemented method of identifying or diagnosing a fault in a structure.

### BACKGROUND

Problems with a property can go unnoticed for a long time and lead to long-term problems with that property. Issues such as mould and damp can start from a position where they are straightforward to address and then later, if left unchecked, can become much larger problems which can influence the structure of the property and the well-being of tenants and owners.

Delays in diagnosing problems in a structure can lead to further damage to that structure and can also compromise the health and safety of those inhabiting the structure. For instance, mould can lead to respiratory problems for individuals who inhabit properties where mount is prevalent.

Aspects and embodiments were conceived with the foregoing in mind.

### SUMMARY

Viewed from a first aspect, there may be provided a computer-implemented method of identifying and/or diagnosing a fault in a building. The fault may be identified by a fault type which describes a type of fault in a building and this may be identified and/or diagnosed by providing a captured content item to the processing resource and then applying a trained model to the image which then identifies a feature of interest in a building (such as, for example, discolouration on a wall) and then uses the presence of that feature to diagnose a problem such as, for example (in the case of discolouration) water damage. Such an example of a fault type may be water damage, flooding or another problem which will require maintenance. Other fault types which may be identified include roof damage (which may be identified and/or diagnosed using an image which shows a loose roof tile), gutter damage (which may be identified and/or diagnosed using an image which shows a gutter which is deformed or surrounded by water staining). A fault type can be described as a type of damage which has occurred to the interior or exterior of a building. Whilst examples described in this specification relate to water damage, this should not be taken to be limiting, the examples are for the purpose of clarity only and are not intended to impose a limitation on the protection which can be provided by the claimed subject matter.

The method may be implemented by a processing resource. The processing resource may be implemented using hardware or software or a combination of both. The processing resource may be cloud implemented and/or implemented using a combination of a mobile computing device and a computing resource external to the mobile computing device.

The method may comprise training a data model to determine a the presence in a content item of a characteristic associated with a fault in a building. The data model may comprise a combination of artificial neural networks and/or convolutional neural network. An example implementation may be ResNet 50.

Other forms of trained model may be used without departing from the scope of the disclosure. For example, the trained model may additionally or alternatively deploy one or more combinations of Region-based Convolutional Neural Networks (R-CNN), Fast R-CNN, Faster R-CNN (e.g. a combination of Fast R-CNN and a Regional Proposal Network (RPN)), You Only Look Once (YOLO), Single Shot Multibox Detector (SSD), RetinaNet (utilising a feature pyramid network (FPN)) and EfficientDet (utilising a Bidrectional Feature Pyramid Network). Other suitable network topologies may be deployed alternate to or in combination with any of those previously stated.

The trained model may be trained using any combination of supervised, unsupervised or semi-supervised learning. Although examples described herein are in the form of supervised learning, other forms of learning may be deployed to train the trained model.

The trained model may be deployed or implemented using any suitable hardware or software resources or a combination of both. The trained model may utilise the hardware resources of a mobile computing device or a cloud based computing resource.

The training may comprise providing a plurality of training content items, each training content item pertaining to a type of fault which can occur in a building among a plurality of faults which can occur in a building. As part of the training and for a given training content item among the plurality. A content item may comprise any combination of images and/or audio-visual content. The training may provide a training input including a label for a feature of interest (e.g. discolouration) associated with a type of fault (e.g. water damage). A feature of interest may be described as a feature which can be identified from the content item which indicates that a fault may exist in the building captured in the image. A label such as, for example, “discolouration”, may then be associated by the model with a type of fault (e.g. “water damage”), i.e. damage which may be demonstrated by the feature of interest.

The training may further provide a training output identifying the type of fault (e.g. flooding or water damage) associated with the feature of interest pertaining to the label. Whilst examples are described in relation to water damage, it will be clear that this is for illustration only and that the teaching of the disclosure could be extended to the diagnosis of any type of damage which can be present in a building.

The method may further comprise implementing by the trained data model the steps of receiving input content captured at a building. The input content may be captured by any suitable computing device such as, for example, a mobile computing device or a camera. This step of implementation of the trained data model may also be described as a step of diagnosing a fault type in a building.

The input content may comprise one or more image components and/or one or more audio visual components such as, for example, video and/or sound. The method may further comprise detecting at least one characteristic in the input content which corresponds to a feature of interest in the plurality of training images.

The method may further comprise detecting that the at least one characteristic is associated with a label in the training input that corresponds to said feature of interest. The method may further comprise identifying that the input content indicates a type of fault at the building. For example, the implementation of the data model may identify “discolouration” (for example) in the image. The method may further comprise providing an output indicating the presence of the type of fault at the building. In the example of discolouration, the output may indicate the presence of “water damage” in the building. The output may comprise a notification containing an indication of the fault type and an image identifying the feature of interest associated with the fault type.

A method in accordance with the first aspect enables a fault in a building to be identified based on content input into a model. This means that a fault can be identified and remedied without waiting for specialist attention and can provide early warning of problems in a building. More particularly, a feature of interest determined to be present in captured content can be used to identify a fault in a building.

One or more steps of the method in accordance with the first aspect may be executed on a device where the input content is captured. Analysis of input content may be carried out on the device or at an external processing medium. This will depend not only on the required processing but also on local privacy laws. In instances where the analysis needs to take place on the device, a less computationally intensive data model implementation may be selected. In other instances, more computationally intensive processing may be transmitted to the cloud. One or more steps may be implemented at a computing resource external to the device where the input content is captured.

The input content may be subject to verification and/or validation checks. This prevents the processing resources from being absorbed by spurious requests based on invalid or malicious data. The output from the implementation of the data model may be further processed to determine the likelihood of other fault types in the building. This may be by further processing of the output from the model by applying inferences from third party data or sensor data from the building.

The trained model may comprise a plurality of artificial neural networks (ANNs) or convolutional neural networks (CNNs). Artificial neural networks (ANN), otherwise known as connectionist systems are computing systems vaguely inspired by the biological neural networks. Such systems “learn” tasks by considering examples, generally without task-specific programming. They do this without any a prior knowledge about the task or tasks, and instead, they evolve their own set of relevant characteristics from the learning/training material that they process. ANNs are considered nonlinear statistical data modeling tools where the complex relationships between inputs and outputs are modelled or patterns are found. ANNs can be hardware-(neurons are represented by physical components) or software-based (computer models) and can use a variety of topologies and learning algorithms. ANNs usually have three layers that are interconnected. The first layer consists of input neurons. Those neurons send data on to the second layer, referred to a hidden layer which implements a function and which in turn sends the output neurons to the third layer. There may be a plurality of hidden layers in the ANN. With respect to the number of neurons in the input layer, this parameter is based on training data. The second or hidden layer in a neural network implements one or more functions. For example, the function or functions may each compute a linear transformation or a classification of the previous layer or compute logical functions. For instance, considering that the input vector can be represented as x, the hidden layer functions as h and the output as y, then the ANN may be understood as implementing a function f using the second or hidden layer that maps from x to h and another function g that maps from h to y. So the hidden layer's activation is f(x) and the output of the network is g(f(x)). The first layer may be an input node which receives an image. The hidden layer may provide input to a decision tree which implements functions based on contextual information such as a particular scenario or fault characteristic. The output may be a probability of a fault characteristic being identified in an image. CNNs can be hardware or software based and can also use a variety of topologies and learning algorithms. A CNN usually comprises at least one convolutional layer where a feature map is generated by the application of a kernel matrix to an input image. This is followed by at least one pooling layer and a fully connected layer, which deploys a multilayer perceptron which comprises at least an input layer, at least one hidden layer and an output layer. The at least one hidden layer applies weights to the output of the pooling layer to determine an output prediction. Either of the ANN or CNN may be trained using images of physical objects or characteristics which may be identified or need to be identified in accordance with the method. The training may be implemented using feedforward and backpropagation technique. The trained model may be trained on fault characteristics associated with at least one fault. This training may comprise training a CNN on images of a fault characteristic. An example of such a fault characteristic may be the presence of, for example, discolouration on a wall which indicates the presence of damp

Optionally, the method may further comprising generating fault metadata associated with the at least one fault and may also generating a fault notification using the fault metadata. The fault metadata may comprise data indicating the features which have been determined to be present in the input content. The metadata may additionally comprise positional data which indicates the position of features relative to the identified fault. The data can then be processed to determine the proximity of the fault relative to the features and then used to identify which third parties can be used to remedy these faults.

The method may further comprise transmitting a fault notification to a computing device. Such a computing device may be identified by a user profile and may correspond to a user who has uploaded the content or a third party. The fault notification may comprise a descriptor of the fault. The method may further comprise, responsive to the determination that the at least one characteristic is associated with a label in the training input that corresponds to said feature of interest obtaining location data (e.g. satellite imagery) associated with the geographic area around the building. The method may further comprise identifying, using the location data, the presence of physical or environmental features around the building. The method may further comprise using the identified physical or environmental features to identify a type of fault at the building.

### DESCRIPTION

An embodiment will now be described by way of example only and with reference to the following drawings in which:

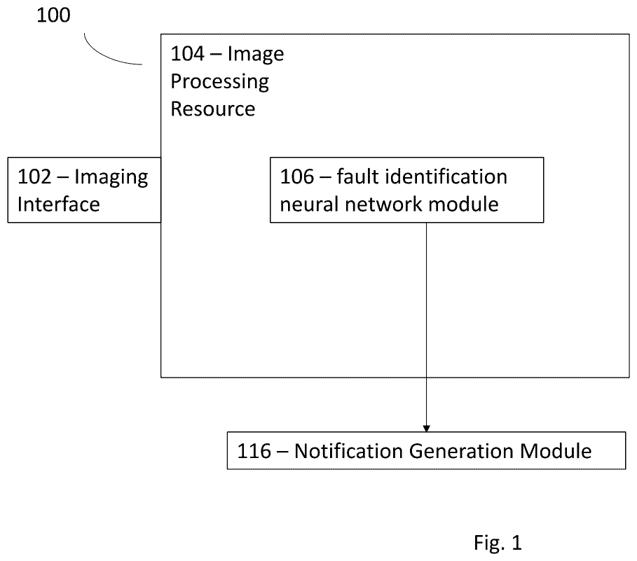

FIG. 1 is a schematic illustration of system in accordance with an embodiment;

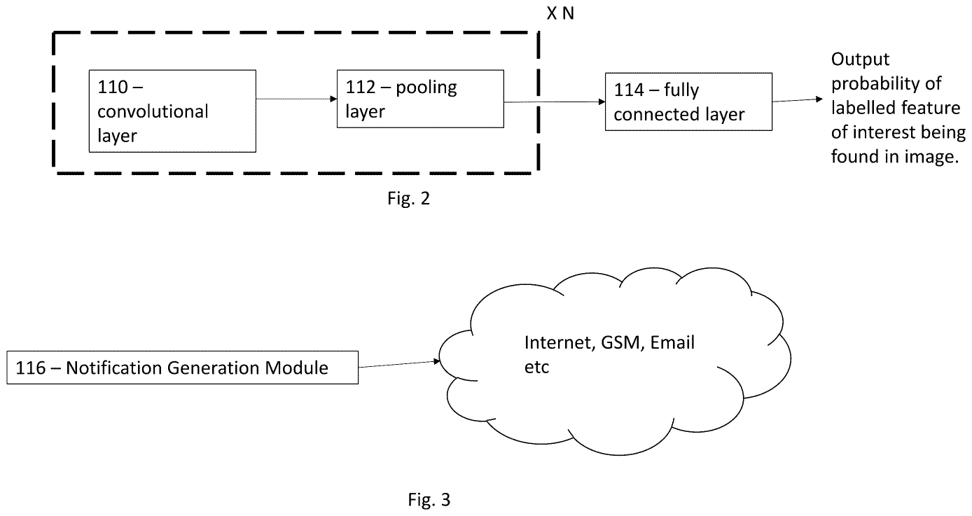

FIG. 2 is a schematic illustration of a fault identification neural network in accordance with an embodiment;

FIG. 3 is a schematic illustration of a notification generation module in accordance with an embodiment;

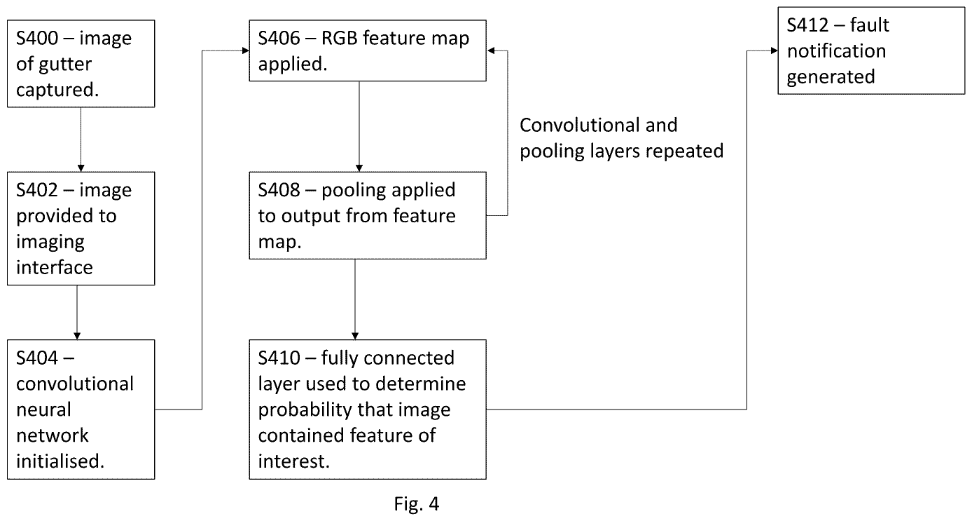

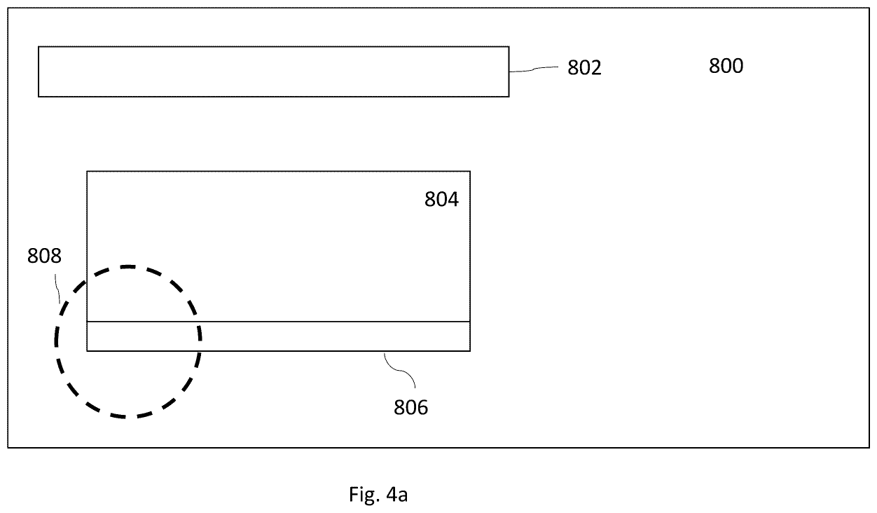

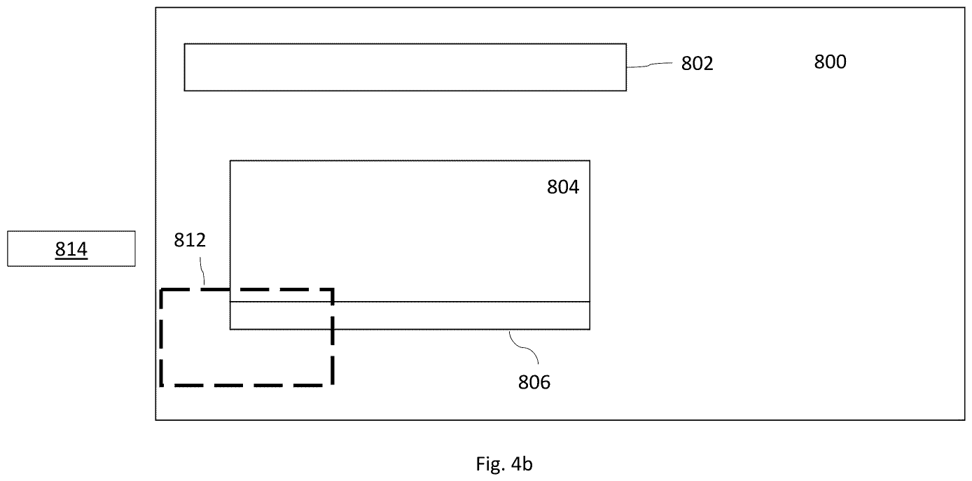

FIG. 4 is a flow chart detailing how a fault in a structure can be identified in accordance with an embodiment;

FIG. 4a is an illustration of an image which may be input to a system in accordance with the embodiment;

FIG. 4b is an illustration of an image which may be output from a system in accordance with the embodiment.

We now describe, with reference to FIG. 1, a first embodiment of a system 100 which may be used to identify a fault in a structure.

The system 100 comprises an image interface 102 and an image processing resource 104 which will now be described in more detail. The system 100 may form part of a mobile computing device such as a mobile telephone or, alternatively, the system may be cloud located or located remotely to a mobile telephone. That is to say, the system 100 may be implemented on a mobile computing device or other computing device. The trained data model may be selected based on which mobile computing device is to be used to implement the trained data model.

The image interface 102 is configured to receive images captured from an imaging device such as, for example, a camera and to convert that image into a format suitable for input into a fault identification neural network module 106. The image interface 102 is also configured to retrieve metadata associated with the captured image.

By converting the image into a format suitable for input into a fault identification neural network module 106, the imaging interface maps each pixel in the image to a matrix where each pixel is represented in the matrix by a pixel value which forms a numerical representation of each pixel. In mapping the image to a matrix of pixel values, the image is converted into a form in which it can be processed by a convolutional neural network (CNN) such as fault identification neural network 106. This will be described in more detail below.

The fault identification neural network 106 is illustrated in FIG. 2. The fault identification neural network comprises a convolutional neural networks (CNN) which comprises at least a convolutional layer 110, a pooling layer 112 and a fully connected layer 114. The convolutional layer 110 receives the matrix of pixel values as an input and is configured to apply a kernel matrix to the input image to implement a feature map onto the matrix of pixel values. The pooling layer 112 applies maximum pooling to the output of the convolutional layer 110. The output from the pooling layer 112 may then be output to a further layer where a subsequent convolutional layer 110 receives the output from the pooling layer (before generating a further output) and then another pooling layer is applied to the further output. That is to say, multiple convolutional and pooling layers may be deployed where a pooling layer provides the input to the subsequent convolutional layer. This may be repeated N times where N can be selected based on the processing capacity of the device which is being used to implement the trained model.

This repeated succession of convolutional and pooling layers implements a deep learning convolutional neural network. The repetition of the convolutional and pooling layers may be repeated many times, e.g. N=50, to enable the convolutional output from the final pooling layer to contain information regarding specific objects in the captured image. The output from the final pooling layer may then be input to the fully connected layer 114.

The fully connected layer 114 then deploys a multilayer perceptron comprising an input layer, at least one hidden layer and an output layer. The output from the pooling layer 112 is provided as input to the fully connected layer 114 where weights and biases are applied to determine an output prediction in the form of a probability that an image contains a feature of interest (e.g. discolouration). The feature of interest can then be associated by the fault identification neural network module 106 with a fault type such as, for example, water damage.

That is to say, the fully connected layer 114 acts as a classification layer for the input image in that it provides an output probability that the image depicts certain features, i.e. features of interest, using the data provided by the succession of convolutional and pooling layers which make up the fault identification neural network 106. The features can then be associated with a fault type.

The convolutional neural network provided by convolutional layer 110, pooling layer 112 and fully connected layer 114 is trained on images of specific faults which can occur in a building. We will now describe the training process in more detail.

The training of the convolutional layer 110, pooling layer 112 (and subsequent iterations thereof) and the fully connected layer 114 is initialised by obtaining a plurality of images of buildings and faults within those buildings. Experts in the different faults in buildings may be used to categorise faults into different fault types and also to identify which features of interest may be present in an image which could be associated with those fault types. The next step is identifying within those images the presence of features of interest which indicate a fault type in the building illustrated in the image. The feature of interest can then be identified with a label. For example, if an image shows discolouration on a wall inside a building then this can be marked with a label “discolouration”. In another example, the presence of mould spots on a wall can be labelled with “mould spots”. This process can be repeated for all features which can be found in an image which are indicative of a type of damage being present within a building. Whilst here we talk about examples which relate to discolouration and water damage, it should be emphasised that is for illustration only and should not be taken to limit the subject matter.

A suitable output from the fully connected layer 114 can then be designated for each of the images. In the example of discolouration, the output can be identified as “mildew”. In the example of “mould spots” then the output can be identified as “damp”. This is because discolouration on walls is indicative of mildew and mould spots on a wall can be indicative of damp. That is to say, the output can be associated with a fault in a building or a type of damage in the building. In another example, a deformed gutter, as a feature of interest which may be present in a captured image, may then be associated with an output “gutter damage” which is a fault type in a building.

This process can then be repeated for images showing a plurality of features of interest which indicate the presence of a mould type. Similarly, it can be repeated for all features of interest which can be identified in an image which can then be associated with a fault type. A suitable output can then be designated for each of the features of interest. It is possible that multiple features of interest may be labelled in the same image and each may be assigned a different fault type.

Forward/backward propagation can then be deployed to optimise the parameters, weights and biases of the convolutional layers, the pooling layers and the fully connected layer. That is to say, the labelling of the feature of interest and the corresponding output (i.e. fault type) is used to train the convolutional neural network to identify and/or diagnose fault types based on an image taken at a building.

The fault identification neural network 106 can be trained on both interior and exterior images to enable it to be trained to identify both interior and exterior fault types.

The use of multiple convolutional and pooling layers means that the fault identification neural network 106 can be used to identify many different features in an image, including both mildew and discolouration in the same image. The training process described here will optimise the parameters of the kernel matrix, the pooling layer and the weights and biases in the fully connected layer to identify the parts of image which contain those features, i.e. the features of interest.

The labelling of the images and the identification of the fault types which correspond to the features of interest is with the assistance of trained professionals who work in the areas of damproofing, decoration and other relevant industries.

As part of the same fault identification neural network module 106, further layers (i.e. of convolution and pooling) may be used to identify objects commonly found in the interior or exterior of a building such as, for example, windows, window sills, doors and roofing. Similar training may be deployed to identify these features to the fault identification neural network 106. Optionally, a separate neural network may be trained to identify these features (i.e. objects commonly found in the interior or exterior or a building) in an image provided to the fault identification neural network module 106.

Examples of these commonly found objects are the type of building (e.g. a house or an apartment), types of windows (e.g. a bay window or a sash window), type of front door (e.g. composite front door), plumbing features (e.g. downpipe), positional characteristics (e.g. end of terrace or semi-detached), roof geometry (e.g. flat roof), door types (e.g. folding doors) and the presence of surrounding trees (e.g. large tree, beech tree) Following training of the convolutional neural networks, they can be used to classify new images and group objects or defects together based on their predicted categories. In one example, if a model was used to classify objects or defects found in a front elevation of a property, it is used to predict categories and to group similar defects together to identify patterns or trends which may indicate a problem with the building.

In practical terms, a suitable convolutional neural network implementation would be ResNet-50 where the convolutional and pooling layers are repeated 50 times. Such an implementation would be trained on the images as described above.

Although the example described uses an example of a CNN, other forms of trained data model could also be utilised to identify fault types in a building based on features of interest found in content provided to the model. The trained model may additionally or alternatively comprise combinations of one or more of R-CNN, Fast R-CNN, Faster R-CNN, YOLO, SSD, RetinaNet, EfficientNet or any other suitable implementation.

These models may be selected based on their respective strengths and/or weaknesses but additionally because of the computational resources which may be available. For example, a model which requires fewer computational resources may be selected if the model is intended to be implemented using a mobile computing device.

Substantial speed-up can, for example, be obtained using Fast R-CNN as the same CNN is used to classify objects and propose regions in an image which contain features of interest. It is faster than R-CNN which generates region proposals and then utilises a CNN to classify objects within those regions. The use of R-CNN reduces the number of regional proposals required for object detection during training.

Further speed can be obtained using Faster R-CNN which utilises a region proposal network to share convolutional features with the detection network.

YOLO may be deployed where speed is required but small objects (or objects which are close together) are not likely to be present in a captured image. This is because the image is processed in a single pass to identify objects. However, given the computationally intensive nature of YOLO it may not be suitable for mobile computing devices but may be suitable for cloud implementations.

SSD is an improvement on YOLO in the sense it can be effective at detecting objects in an image which are at different scales.

RetinaNet may be selected if it is suspected that there may be a training dataset which may exhibit foreground and background imbalance.

EfficientDet is accepted to be more efficient at object detection in an image and so may be utilised where computational resources are limited.

Having trained the data model to identify the presence of features of interest which are associate with fault types, we can now describe how a fault type can be diagnosed based on an image provided to the data model. This will now be described with reference to FIG. 4. This will be discussed using an example of discolouration on a wall of a building. Discolouration can be identified as a feature of interest and used to diagnose a fault, as will now be described. This example is not intended to be limiting but merely illustrate the workings of the image processing resource 104. We will show that the training enables the convolutional neural network provided by the fault identification neural network module 106 can be used to diagnose a fault in a building.

In a step S400, an inhabitant of dwelling captures an image of a wall with a gutter at least partially along the wall. The image is illustrated in FIG. 4a where the gutter 802 is attached to the wall 800. The image is captured by a camera on a mobile telephone (but can be captured on any other suitable mobile computing device). There is a window 804 beneath the gutter with a wooden sill 806. There is a region of discolouration 808 in the vicinity of the wooden sill 806. This is causing concern to the individual capturing the image. The discolouration is causing brown stains on the wall 800 and is due to water staining due to leakage from around the window sill. This issue is unbeknown to the individual who has captured the image.

In a step S402, the image is provided to the imaging interface 102 which converts the image into a format which is suitable for processing by the fault identification neural network module 106, i.e. a matrix of pixel values is generated using the captured image and this is used in the subsequent processing. The imaging interface 102 will also be configured to receive metadata associated with the image. The metadata associated with the image may comprise the time the image was taken, global positioning system (GPS) data, and resolution of the image. If the resolution of the image is below a resolution threshold, then the image may be rejected at this stage as not being of sufficient quality.

Additionally, the fault identification neural network module 106 may apply validation and verification to the received image.

Validation may be achieved simply by only accepting file types which are typically used for an image such as .png or .jpeg file types. Further validation may also be applied by applying a validation procedure which checks that the image is of a building. This may be applying standard image segmentation techniques to the image to determine the presence of features typically found in a building. For example, the image segmentation techniques may determine the shape of a building is present in the image. In another example, the image segmentation techniques may determine the presence of another object such as a photograph hanging on a wall. If the validation fails then the fault identification neural network identification module 106 may request another photograph.

Validation may also be achieved by contacting the user on another communication channel to ask them to capture another image of the building in question or even just to ask if they had intended to upload the image.

Image verification may be implemented by running a consistency check on the images EXIF data to determine when and where it was made. It the check determines the image was actually generated many years ago then this check will fail as it is clearly not an up to date photograph of the building. Other standard techniques can also be used. In the event a verification check fails, another image may be requested.

By validating and verifying an uploaded image, the fault identification neural network module can avoid being clogged up by malicious third parties who want to occupy the resources of the image processing resource 104 with spurious images.

When the image has been received and converted into a format suitable for processing by the convolutional layer, we can then initialise the fault identification neural network module 106 so that it can be used in an implementation phase to determine the presence of fault types in buildings based on images captured of those buildings. That is to say, the trained convolutional neural network provided by the fault identification neural network module 106 is used to diagnose the presence of faults based on the determined presence of features of interest in the captured image. The image processing resource 104 will then initialise the convolutional neural network which is provided by the fault identification neural network 106. This is step S404.

In a step S406, the convolutional layer 110 of the convolutional neural network (in the fault identification neural network module 106) applies a Red Green Blue (RGB) feature map to the matrix of pixel values is generated from the image The output from the RGB feature map generates a numerical representation of the image in the form of a matrix wherein each element of the matrix corresponds to a subset of the pixels of the captured image. The pooling layer 112, in a step S408, then applies a max pooling function which takes the maximum element of each matrix generated by the feature map. By taking the maximum of each matrix, the max pooling function will identify the element of the matrix with the largest value and return the value of that element with an identifier of the element. This means that groups of pixels which contain the darker red (or brown due to water staining) will be returned from the max pooling function as they will contribute the largest amounts to the matrix generated by the feature map. This is because the kernel matrix used in the convolution layer 112 comprises elements which are optimised to provide a larger value if the subject image comprises discolouration. Steps S406 and S408 are repeated for each of the convolutional and pooling layers in the convolutional neural network implemented by the fault identification neural network module 106. That is to say, the discolouration will be identified as a feature of interest in the image as the convolutional and pooling layers are configured so that the discoloured region in the captured image provides a larger value to the subsequent processing.

The repeated convolutional and pooling layers generates a dataset where the data corresponds to the features in the image such as the window, the window sill, the gutter and the discolouration.

The dataset is then provided to the fully connected layer which comprises a multi-layer perceptron where each layer in the multi-layer perceptron is connected by a series of weights and biases. The weights and biases are optimised during the training process to identify features corresponding to those which were labelled during the training process. Discolouration was identified as a label when an input image containing discolouration was used in the training process and an output was designated as water damage. The fully connected layer provides an output probability of more than 90% that a window sill and a window is present and a region of water damage is present as it is trained to associate discolouration with water damage during the training process. This is step S410. That is to say, the convolutional neural network is trained to identify a region of water damage as an output which is associated with the label “discolouration”. This is because the convolutional neural network is trained by labelling discolouration and identifying water damage as a fault type which is associated with discolouration. In another example of a fault type, a clogged gutter may be associated with a deformed gutter as a feature of interest. This will enable the convolutional neural network to receive an image of a building which captures a swollen or bowing gutter and then associate that with a clogged gutter. The clogged gutter can then be diagnosed without the need for preliminary examination or without the risk of the resident hurting themselves by investigating themselves.

That is to say, in more general terms, if content is uploaded which contains a characteristic which corresponds to a feature of interest, then this can be used to diagnose a fault type in the building as the CNN is trained to associate the feature of interest with the fault type.

This output from the fully connected layer generates metadata which contains the data identifying the presence of a window sill, a window and water damage in the captured image. The metadata also contains the positional data corresponding to these features on the captured image.

The fault identification neural network module 106 then determines, using the positional data, the proximity of the discolouration to the window sill. The positional data indicates the discolouration is close to the window sill by determining the distance of the discoloured region to the window sill.

That is to say, once the output has been obtained from the fully connected layer, a further processing step may be applied which determines the position of the features of interest in the image and whether, for example, the fault type is near to any of the features. This can then be used to diagnose the problem.

In step S412, the fault identification neural network module 106 generates a fault metadata notification. The fault metadata notification is generated using a chatbot (or other natural language generation tool) which is configured to aggregate the information returned from the convolutional neural network implemented by the fault identification neural network module 106 to generate a phrase which is included in the notification. The phrase may read “There is likely to be water damage around the window sill. This may be included in a textbox 814 near to the location of the water damage.” This is because the processing of the output from the fully connected layer determines that the water damage is near to the window sill. In another example, the processing may determine the water damage is beneath the gutter and a different inference may be determined. In this instance, the chatbot may generate the phrase “It is likely you have a clogged gutter as there is discolouration beneath your gutter”.

A bounding box 812 can then imposed onto the image where the discolouration is present using the positional data which corresponds to the discolouration. The bounding box in this instance provides an identifier for the feature of interest which is associated with the diagnosed fault type. A text-based indicator can also be included which says “suspected water damage”. This is illustrated in FIG. 4b.

The notification is then provided to the mobile computing device which captured the image. It is sent using the notification generation module 116 which converts the data into a format suitable for transmission to a mobile computing device or display on the screen of the mobile computing device on which the system 100 is implemented. The notification may be provided to an alternative mobile computing device or may be transmitted to an email address or other suitable address for the user, i.e. sent by SMS or a messaging application.

The diagnosis of the fault in the building can then be used in remediation of the fault by the system 100.

The notification generation module 116 may also be configured to retrieve contact details for a professional associated with remediation of the fault type identified by the fault identification neural network module 106. The contact details may then be included in the notification. Additionally or alternatively, the notification generation module 116 may generate a message to be transmitted to a professional associated with remediation of the fault type and then send the message with the contact details of the person who captured the image in step S400.

In this example, the notification generation module 116 will identify from the metadata generated by the fault identification neural network module 106 that a professional who can remedy water damage may be required and the contact details can then be retrieved from a contact database. A message can then be transmitted to the corresponding address which contains the contact details of the person who captured the image. The message can also be sent to a third party such as a landlord or property manager.

The notification generation module 116 is configured to utilise any suitable telecommunications network to transmit the message, as illustrated in FIG. 3.

Additionally or alternatively, metadata obtained when the image is provided may comprise location data such as, for example, GPS data. The fault identification neural network module 106 may be configured to access satellite data and/or data from other sources relating to climate data and environmental data. This can then be used to draw inferences about potential problems at the building in the captured image.

For example, the location data may be provided to a source of satellite imaging data with a time frame such as, for example, the previous three weeks or even the previous twelve months. The location data and the specified time frame may be accompanied with a request for rainfall data for that period.

The rainfall data for the location around the building may then be obtained. If the rainfall data indicates the rainfall has been high during the previous three weeks then this can be used by the fault identification neural network module to determine that the rainfall on the building may have caused overflow in the gutter 802 identified in the captured image. This can be added to the notification which is sent to the person who captured the image. This may be accompanied with contact details for a gutter specialist. Indeed, the notification generation module 116 may also contact the gutter specialist. This may be relevant in a city which experiences high rainfall throughout the year.

Alternatively, the rainfall data for the location may indicate the rainfall data is low for the location. The notification generation module 116 may then determine that a gutter specialist is not required but that the window may well be faulty and a window specialist is similarly required. This may be the case in a city which experiences very low rainfall throughout the year such as, for example, Cairo in Egypt.

By enabling the location of the property to be used to gather more data about potential problems in the building, such problems can be averted or addressed before they become apparent. In the above example, the water damage specialist may be called and may address the water damage but a roof which is damaged by rainfall will keep causing the problem to resurface. Therefore, identifying the high rainfall using the location data will mean the problem is less likely to resurface as a roof specialist can be summoned to address a problem with a rain damaged roof, thereby mitigating repeated problems with water damage in the window sill.

Optionally or additionally, external (and third party) data sources such as, for example, energy performance certificate data can also be used to diagnose problems using system 100. One example of this may be where heat loss is occurring around a window in a house due to damage to the surrounding concrete. The damage to the surrounding concrete may not be identified by the CNN as it may not be identifiable from the image. If the energy consumption for the house is higher than the average for a house of a similar EPC then this may be indicative of damage to the concrete around the windows. The fault identification neural network module 106, having identified the windows, may also receive the energy consumption data and infer the presence of damage to the concrete around the windows. That is to say, the windows would be identified as a feature of interest and the energy consumption and the windows would be used to diagnose the damaged concrete.

Optionally or additionally, the imaging interface 102 may be configured to receive multimedia input comprising audio-visual components in the form of a stream of video. This can be used to capture more dynamic effects within a building such as a draft or water flowing down a wall. The fault identification neural network module 106 may be configured to apply a rolling prediction average approach to a video stream in order to output probabilities of labelled characteristics being found in a video stream.

In such an implementation, the fault identification neural network module 106, the fault identification neural network module 106 loops over all of the frames in the video stream and passes each frame through the convolutional neural network implemented by the fault identification neural network module 106. The output probabilities are then provided as output from the convolutional neural network which indicate the probability of the labelled dynamic features of interest such as, for example, water flowing down a wall which can then be associated with flooding. A list of the most recent 10 predictions (i.e. predictions over the last 10 frames) can then be maintained and the average can then be taken. The output with the largest output probability can then be taken as indicative of the dynamic features which are present in the video stream.

That is to say, in the convolutional neural network provided by the fault identification neural network 106 can be trained to determine the presence of dynamic features in that water flowing over a surface (for example) can be labelled as indicative of flooding as a type of fault. This can then be used in forward/backward propagation to train the convolutional neural network to recognise dynamic features in video streams.

Additionally or alternatively, the fault identification neural network 106 can be configured to determine the presence of features of interest based on audio input. An example may be a draft in a house which comes through a hole in a window. It may be difficult to record this using an image or a video but it may be possible to record the sound of the draft. An audio file may be captured by a mobile telephone and uploaded to the fault identification neural network 106 via the imaging interface 102 or even another interface configured for receiving audio files. A suitable format for such a file may be a .WAV file, an AIFF file, a FLAC file or an MP3 file. Standard digital signal processing techniques may be applied to the audio file.

The convolutional and pooling layers may not be required for the analysis of an audio file. Rather a standard artificial neural network may be configured and trained to recognise the presence of a draft in an audio file based on the output from a dataset which is received as the output from the application of a digital signal processing technique to an uploaded audio file.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as whole. In the present specification, “comprises” means “includes or consists of” and “comprising” means “including or consisting of”.

The singular reference of an element does not exclude the plural reference of such elements and vice-versa. The invention may be implemented by means of hardware comprising several distinct elements, and by means of a suitable programmed computer. In a device claim enumerating several means, several these means may be embodied by one and the same item of hardware. The mere fact that certain measures are recited in mutually different dependent claims does not indicate that a combination of these measures cannot be used to advantage.

1. A computer-implemented method of identifying a fault in a building, the method implemented by a processing resource, the method comprising:
training a data model to determine a the presence in a content item of a characteristic associated with a fault in a building, the training comprising:
providing a plurality of training content items, each training content item pertaining to a type of fault which can occur in a building among a plurality of faults which can occur in a building;
for a given training content item among the plurality:
providing a training input including a label for a feature of interest associated with a type of fault in the given training image;
providing a training output identifying the type of fault associated with the feature of interest pertaining to the label;
the method further comprising, implementing by the trained data model the steps of receiving input content captured at a building;
detecting at least one characteristic in the input content which corresponds to a feature of interest in the plurality of training images;
detecting that the at least one characteristic is associated with a label in the training input that corresponds to said feature of interest;
identifying that the input content indicates a type of fault at the building; and
providing an output indicating the presence of the type of fault at the building.

2. The method of claim 1 wherein the data model comprises an artificial neural network (ANN).

3. The method of claim 1, wherein the data model comprises a convolutional neural network (CNN).

4. The method of claim 1, wherein the method comprises generating a fault notification containing an output indicating the type of fault.

5. The method of claim 4 wherein the method further comprises providing an image identifying the fault.

6. The method of claim 1, the method further comprising generating fault metadata associated with the at least one fault; and generating a fault notification using the fault metadata.

7. A method according to claim 1, the method further comprising transmitting a fault notification to a computing device.

8. The method of claim 1, wherein the method further comprises, responsive to the determination that the at least one characteristic is associated with a label in the training input that corresponds to said feature of interest:
obtaining location data associated with the geographic area around the building;
identifying, using the location data, the presence of physical or environmental features around to the building; and
using the identified physical or environmental features to identify a type of fault at the building.

9. The method of claim 8, wherein the location data relates to a specifically defined time period.

10. The method of claim 9 wherein the specifically defined time period is defined in a request.

11. The method of claim 1 wherein the feature of interest comprises discoloration of a surface of a building.

12. A system configured to implement the method claim 1.

13. A non-transitory storage medium which, when executed by a processing resource, is configured to execute the method of claim 1.
